(19) United States
(12) Patent Application Publication
(10) Pub. No.: US 2011/0279030 A1
(43) Pub. Date: Nov. 17, 2011

(54) PLASMA DISPLAY PANEL AND MANUFACTURING METHOD THEREOF

(76) Inventors: Takayuki ASHIDA, Osaka (JP); Tomohiro OKUMURA, Osaka (JP); Shuzo TSUCHIDA, Nara (JP); Mamoru WATANABE, Osaka (JP)

(21) Appl. No.: 13/098,524

(22) Filed: May 2, 2011

(30) Foreign Application Priority Data
May 13, 2010 (JP) 2010-110710

(51) Int. Cl. H01J 17/49; B32B 17/00

(52) U.S. Cl. 313/582; 156/145

(57) ABSTRACT

A front plate and a back plate are superposed with each other in parallel, and pressed onto each other. Moreover, the back plate and a gas-blowing jig are brought into close contact with each other. The glass pipe in which a glass fiber filter paper is placed is pressed onto the back plate, with a solid-state glass frit ring interposed therebetween. Thus, by using a glass pipe, a nitrogen, Xe, or Ne gas is supplied into the panel, or the inside of the panel is evacuated.

### BACKGROUND OF THE INVENTION

The present invention relates to a plasma display panel (hereinafter, referred to as PDP=Plasma Display Panel) for use in image display of a television, a computer, or the like, and a method for manufacturing the plasma display panel.

For example, as shown in FIG. 8, a surface discharge type PDP with three-electrode structure is provided with paired electrodes 152 formed by a pair of display electrodes 152a and 152b that are disposed on a front plate 151 serving as a first glass substrate, so as to be adjacent to each other in parallel with each other, and address electrodes 153 that are arranged so as to be orthogonal to the paired electrodes 152. On the back surface of the front plate, a dielectric layer 154 and a protective layer 155 are formed. Surface discharge cells (main discharge cells for display) are divided and defined by the display electrodes 152a and 152b, and each address discharge cell for use in selecting a light-on or light-off state of a unit light-emitting region is divided and defined by the display electrodes 152b and the address electrodes 153. A phosphor layer 156 is formed so as to coat an inner surface of a back plate 157 serving as a second glass substrate, together with the address electrode 153, along barrier ribs 158, and is excited by ultraviolet rays generated by a surface discharge between the display electrodes 152a and 152b so as to emit light. The light generated by the phosphor is taken out in a display direction of FIG. 8 so that image display is achieved.

Upon carrying out full-color display, phosphor layers 159R, 159G, and 159B having so-called three primary colors of R(red), G(green), and B(blue) are made associated with respective pixels (dots) forming a display screen. A dielectric layer 160 is formed between the phosphor layers 159R, 159G, and 159B and the address electrodes 153 (see, for example, Japanese Unexamined Patent Publication No. 2002-216620). Normally, each of the phosphor layers 159R, 159G, and 159B is formed by successively applying phosphor paste mainly composed of particle-state phosphor substances having predetermined light-emitting colors for each of the colors by using a screen printing method, and by subjecting the resulting paste to a firing process.

The operating voltage of the PDP depends on a secondary electron emission coefficient of the protective layer 155. Therefore, a method has been proposed in which, by using, as the protective film, an oxide of alkali-earth metal (for example, calcium oxide, strontium oxide, or barium oxide) whose work function is smaller than that of magnesium oxide, the operating voltage is lowered. However, oxides of these alkali-earth metals have high hygroscopic property, and after the formation of the protective layer, moisture in the atmosphere is absorbed therein to cause the surface of the protective layer 155 to be altered into hydroxides to form an altered layer, with the result that an instable discharging characteristic is exerted. In order to resolve this issue, methods have been proposed in which, after the protective layer forming process, processes up to the sealing process are continuously carried out in a dry atmosphere (see, for example, Japanese Unexamined Patent Publication No. 2002-231129), and in which, after the protective layer forming process, processes up to the sealing process are continuously carried out in a vacuum atmosphere (see, for example, Japanese Unexamined Patent Publication No. 2000-156160).

The method in which, after the protective layer forming process, processes up to the sealing process are continuously carried out in an atmosphere-controlled space, is a method for preventing the protective layer that has been formed from absorbing impurities such as moisture and the like, but on the other hand, another method is proposed in which the protective layer to which impurities have been adsorbed is sealed, while being subjected to a purifying process. For example, a method has been disclosed in which, first and second glass pipes are attached to the front plate or the back plate, and by supplying a dry gas into the inside of the panel through the second glass pipe, with the inside of the panel being evacuated from the first glass pipe, residual impurities inside the panel are reduced (see, for example, Japanese Unexamined Patent Publication No. 2002-250938). Moreover, another method has been disclosed in which, a heating furnace in which the front plate and the back plate being superposed with each other are placed, is tightly closed, and while an atmospheric gas is being introduced into the heating furnace, gases inside the heating furnace are discharged so that a panel sealing process is carried out (see, for example, Japanese Unexamined Patent Publication No. 2001-35372).

However, the conventional methods for manufacturing a PDP have issues in that the altered layer formed on the surface of the protective layer cannot be removed easily at low costs, without causing variations in the respective panels.

### SUMMARY OF THE INVENTION

In view of the above conventional issues, an object of the present invention is to provide a plasma display panel that is capable of reducing an amount of gas leakage from a periphery of a glass pipe as much as possible upon supplying a dry gas, has a protective layer having stable characteristics with high performance, and is stable in characteristics for a long period of time with high efficiency, and a method of manufacturing the plasma display panel.

In accomplishing these and other aspects, according to a first aspect of the present invention, there is provided a method for manufacturing a plasma display panel comprising:

preparing a first glass substrate having an electrode, a dielectric layer, and a protective layer formed thereon, and a second glass substrate having an electrode, a dielectric layer, a barrier rib, and phosphor layers formed thereon;

disposing a glass frit on the first or second glass substrate;

superposing the first glass substrate and the second glass substrate with each other so that a top portion of the glass frit comes into contact with the glass substrate with no glass frit applied thereto;

disposing a glass fiber member, a glass pipe, and a solid-state glass frit near a through hole formed on the first or second glass substrate;

blowing a gas into a space between the first and second glass substrates via the through hole formed on the first or second glass substrate, and the glass;

fusing the glass frit so that the first and second glass substrates are sealed with each other, with the glass pipe being bonded to the first or second glass substrate;

evacuating a space between the first and second glass substrates; and

enclosing an enclosed gas between the first and second glass substrates.

According to a second aspect of the present invention, there is provided the method for manufacturing a plasma display panel according to the first aspect, wherein a protective layer, which includes at least one kind selected from a group consisting of magnesium oxide, calcium oxide, strontium oxide, and barium oxide, is used as the protective layer.

According to a third aspect of the present invention, there is provided the method for manufacturing a plasma display panel according to the first aspect, wherein a protective layer, which is made from a mixture of at least two kinds selected from a group consisting of magnesium oxide, calcium oxide, strontium oxide, and barium oxide, is used as the protective layer.

According to a fourth aspect of the present invention, there is provided the method for manufacturing a plasma display panel according to any one of the first to third aspects, wherein, upon disposing the glass fiber member on a bonded portion of the glass pipe, a cone-shaped glass fiber member is placed on an inner surface of the glass pipe.

According to a fifth aspect of the present invention, there is provided the method for manufacturing a plasma display panel according to any one of the first to third aspects, wherein, upon bonding the glass pipe, the glass pipe is bonded to a periphery of the through hole, with a solid-state glass frit interposed therebetween, so that the glass fiber member is sandwiched between the glass substrate on which the through hole is formed, and the solid-state glass frit, or between the glass pipe and the solid-state glass frit.

According to a sixth aspect of the present invention, there is provided a plasma display panel comprising:

a first glass substrate having a protective layer;

a second glass substrate which is placed so as to be opposed to the first glass substrate to form a discharging space therebetween, with a peripheral portion between the first substrate and the second substrate being sealed with a sealing member, and with a glass pipe for use in sealing a gas into the discharging space or evacuating a gas therefrom being bonded to a periphery of a through hole formed on the first glass substrate or the second glass substrate so as to be connected to the through hole, wherein

a glass fiber member is disposed on a bonded portion of the glass pipe which is bonded to the periphery of the through hole formed on the first glass substrate or the second glass substrate.

According to a seventh aspect of the present invention, there is provided a The plasma display panel according to the sixth aspect, wherein the protective layer includes at least one kind selected from a group consisting of magnesium oxide, calcium oxide, strontium oxide, and barium oxide.

According to an eighth aspect of the present invention, there is provided a The plasma display panel according to the sixth aspect, wherein the protective layer is made from a mixture of at least two kinds selected from a group consisting of magnesium oxide, calcium oxide, strontium oxide, and barium oxide.

According to a ninth aspect of the present invention, there is provided the plasma display panel according to any one of the sixth to eighth aspects, wherein the glass fiber member disposed on the bonded portion of the glass pipe is a cone-shaped glass fiber member placed on an inner surface of the glass pipe.

According to a 10th aspect of the present invention, there is provided the plasma display panel according to any one of the sixth to eighth aspects, wherein, on the bonded portion of the glass pipe, the glass pipe is bonded to the periphery of the through hole, with a solid-state glass frit interposed therebetween, so that the glass fiber member is sandwiched between the glass substrate on which the through hole is formed, and the solid-state glass frit, or between the glass pipe and the solid-state glass frit.

As described above, according to the plasma display panel and the manufacturing method thereof of the present invention, it is possible to provide the method for manufacturing the plasma display panel which can reduce an amount of gas leakage from the periphery of the glass pipe as much as possible upon supplying a dry gas, by disposing a glass fiber member on a bonded portion of the glass pipe bonded to the periphery of the through hole formed on the first glass substrate or the second glass substrate, and easily remove an altered layer on the surface of the protective layer at low costs, without causing variations in the respective panels, and is superior in panel lifetime.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1A is a perspective view showing a schematic structure of a PDP according to a first embodiment of the present invention;

FIG. 1B is a flow chart showing a schematic structure of a manufacturing process of the PDP according to the first embodiment of the present invention;

FIG. 2 is a side view showing a panel state according to the first embodiment of the present invention;

FIG. 3 is a plan view showing the entire panel according to the first embodiment of the present invention;

FIG. 4 is a cross-sectional view showing a peripheral layout of a glass pipe prior to a sealing process according to the first embodiment of the present invention;

FIG. 5 is a cross-sectional view showing the peripheral layout of the glass pipe after the sealing process according to the first embodiment of the present invention;

FIG. 6 is a cross-sectional view showing a peripheral layout of a glass pipe prior to a sealing process according to a second embodiment of the present invention;

FIG. 7 is a cross-sectional view showing a peripheral layout of a glass pipe after the sealing process according to the second embodiment of the present invention; and

FIG. 8 is a perspective view showing a schematic structure of a conventional PDP.

### DETAILED DESCRIPTION OF THE PREFERRED EMBODIMENTS

Before the description of the present invention proceeds, it is to be noted that like parts are designated by like reference numerals throughout the accompanying drawings.

Hereinafter, embodiments of the present invention will be described with reference to the drawings.

### First Embodiment

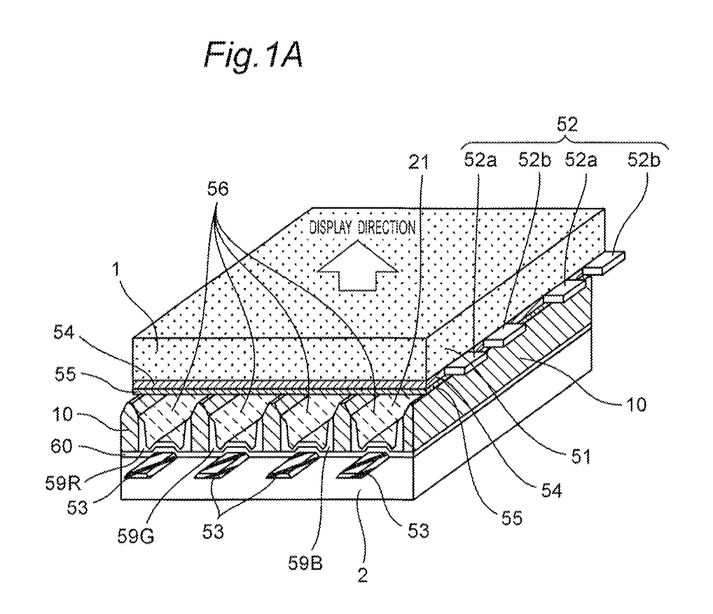

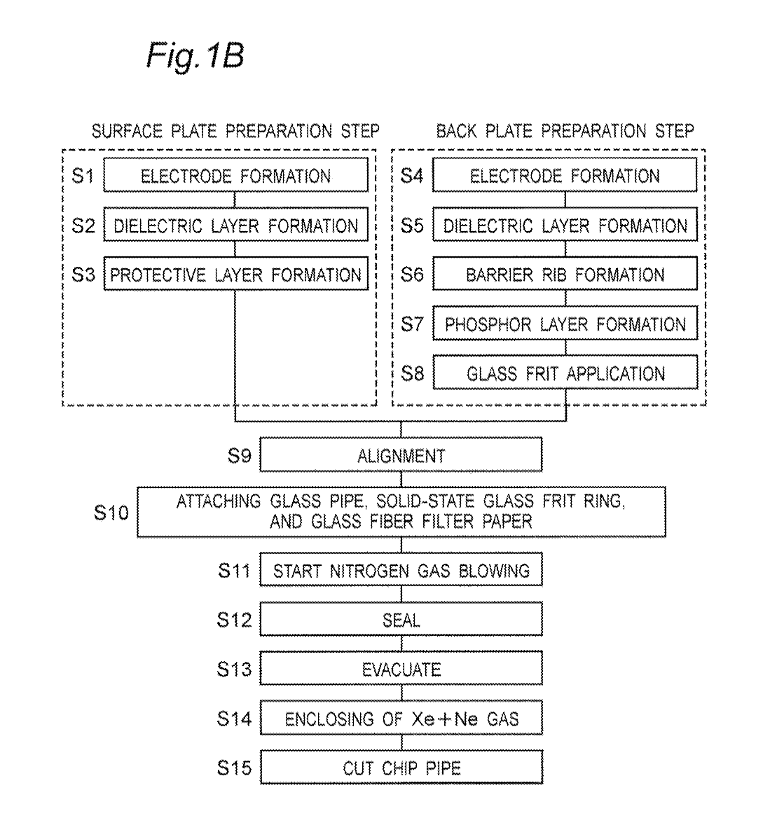

Hereinafter, a PDP (plasma display panel) according to a first embodiment of the present invention will be described with reference to FIGS. 1A to 7.

First, the structure of the PDP will be described.

For example, as shown in FIG. 1A, a surface discharge type PDP with three-electrode structure is provided with paired electrodes 52 formed by a pair of display electrodes 52a and 52b that are disposed on a front plate 1 serving as one example of a first glass substrate, so as to be adjacent to each other in parallel with each other, and address electrodes 53 that are arranged so as to be orthogonal to the longitudinal direction of the paired electrodes 52. On the back surface of the front plate 1, a dielectric layer 54 and a protective layer 55 are formed. Surface discharge cells (main discharge cells for display) are divided and defined by the paired display electrodes 52a and 52b, and each address discharge cell for use in selecting a light-on or light-off state of a unit light-emitting region is divided and defined by each of the display electrodes 52b and each of the address electrodes 53. Phosphor layers 56 are formed so as to coat the inner surface of the back plate 2 serving as one example of a second glass substrate, together with the address electrodes 53, along barrier ribs 10, and are excited by ultraviolet rays generated by surface discharges between the display electrodes 52a and 52b so as to emit light. The light generated by the phosphor is taken out in a display direction of FIG. 1A so that image display is achieved.

Upon carrying out full-color display, phosphor layers 59R, 59G, and 59B having so-called three primary colors of R(red), G(green), and B(blue) are made associated with respective pixels (dots) forming a display screen. A dielectric layer 60 is formed between each of the phosphor layers 59R, 59G, and 59B and the address electrode 53 (see, for example, Japanese Unexamined Patent Publication No. 2002-216620). Generally, each of the phosphor layers 59R, 59G, and 59B is formed by successively applying phosphor paste mainly composed of particle-state phosphor substances having predetermined light-emitting colors for each of the colors by using a screen printing method, and by subjecting the resulting paste to a firing process.

FIG. 1B is a flow chart showing a schematic structure of manufacturing processes of the PDP in the first embodiment of the present invention.

A manufacturing method of the plasma display panel includes the steps of:

preparing a first glass substrate 1 on which electrodes 52, a dielectric layer 54, and protective layers 55 are formed, and a second glass substrate 2 on which electrodes 53, a dielectric layer 60, barrier ribs 10, and phosphor layers 59R, 59G, and 59B are formed (steps S1 to S7);

disposing a glass frit 8 on the first or second glass substrate (step S8);

superposing the first glass substrate and the second glass substrate on each other so as to make a top portion of the glass frit and the glass substrate on which no glass frit has been applied comes into contact with each other (step S9);

disposing glass fiber members 9, 11, and 12, a glass pipe 3, and a solid-state glass frit 4 in proximity to a through hole 7 formed on the first or second glass substrate (step S10);

blowing a gas into a space 20 between the first and second glass substrates via the through hole formed on the first or second glass substrate and the glass pipe (step S11);

bonding the glass pipe to the first or second glass substrate, while sealing the first and second glass substrates by fusing the glass frit (step S12);

evacuating the space between the first and second substrates (step S13); and

enclosing an enclosed gas between the first and second glass substrates (step S14). In the following, each of the steps will be described in detail.

First, in FIG. 1B, the preparing step of the front plate 1 serving as one example of the first glass substrate includes sub-steps of an electrode formation step S1, a dielectric layer formation step S2, and a protective-layer formation step S3.

The preparing step of the back plate 2 serving as one example of the second glass substrate can be carried out simultaneously in parallel with the preparing step of the front plate 1, and includes sub-steps of an electrode formation step S4, a dielectric layer formation step S5, a barrier-rib formation step S6, a phosphor layer formation step S7, and a peripheral sealing glass frit applying step S8.

Each of these sub-steps can be achieved by well-known thin-film/thick-film forming techniques, such as a sputtering method; a vapor deposition method; a photolithography method; a screen printing method; a die-coating method; or a sand-blasting method, or fine-machining techniques, and thermal processes, such as drying and firing processes.

The peripheral sealing glass frit to be used here is prepared by adding a vehicle containing a resin such as methylcellulose or nitrocellulose, and a solvent, such as α-terpineol or amyl acetate, to a sealing material formed by uniformly mixing low-melting-point glass powder of a PbO-based, P₂O₅—SnO-based, or Bi₂O₃-based material with a filler, so as to be mixed and stirred to form a paste. This paste-state glass frit material is heated to a fusing temperature, and then cooled down to be solidified so that the front plate 1 and the back plate 2 can be sealed.

In this manner, after the front plate 1 and the back plate 2, respectively prepared, have been aligned (position-adjusted) in an alignment device, the two glass substrates 1 and 2 are brought into close contact with each other and held, with a square-frame-shaped glass frit 8 (see FIG. 3) being interposed therebetween (alignment step S9).

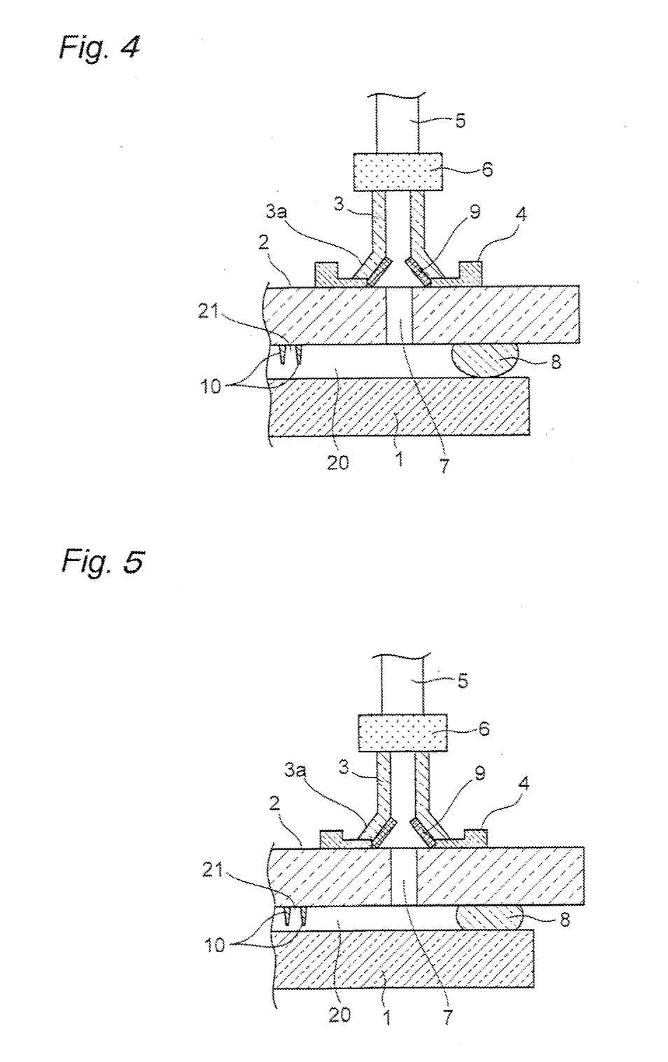

Next, in association with an exhaust through hole 7 (see FIG. 3) formed on the back plate 2, a cone-shaped glass fiber filter paper 9 (see FIG. 4) serving as one example of a glass fiber member, a solid-state glass frit ring 4 having a round-frame shape or a square-frame shape, serving as one example of a sealing member, and a glass pipe 3 serving as one example of a gas-blowing jig are respectively attached (step S10). From the formation step of the protective layer 55 (S3) to this step S10, since the protective layer 55 is exposed to the atmospheric air, an altered layer is formed on the surface of the protective layer 55.

For example, the fiber filter paper 9 to be used here contains no binder, and is made of only ultra thin glass fibers of borosilicate having a diameter in a range of from about 0.1 to 1 μm, and the pressure loss at the time when the thickness is about 0.15 to 0.75 mm, with a ventilation velocity of 5 cm/s, is set to 0.17 kPa or more, and has a funnel shape in a manner so as to be fitted along the a flare portion 3a of the glass pipe 3. The lower limit value is set to 0.17 kPa because, among commercially available products, this value corresponds to a specified value of the inexpensive product with the least pressure loss. As the upper limit value, since the gas leakage hardly occurs as the pressure loss becomes greater, and since this is considered to be advantageous, the upper limit value is not particularly required to be specified.

By using glass fibers containing no binder, alteration does not occur even if heated to about 500° C. at the time of sealing, and the pressure loss of a fixed level or more can be maintained, without causing any generation of impurity gases. In the first embodiment, a glass fiber filter paper, made of only the ultrathin borosilicate glass fibers, is used; however, other glass fiber products that can realize the same shape, pressure loss, and heat resistance may be used.

Moreover, the solid-state glass frit 4 to be used here is produced through processes in which the same paste-state glass frit as that used for the peripheral sealing is filled into a press-molding metal mold, and after having been press-molded into a round frame shape or a square frame shape, the resulting glass frit is temporarily fired at about 200 to 350° C. so that the resin components are volatilized and burned, and then sintered at 330 to 430° C. The sealing material to be used for manufacturing the solid-state glass frit ring 4 is the same as the peripheral sealing glass frit paste, and a fusing temperature is also the same, and by carrying out a press-molding process using a press-molding metal mold, a required shape can be formed with high precision as compared with paste application.

Next, a nitrogen gas blowing process into the space (space inside the panel) 20 among the glass frit 8, the front plate 1, and the back plate 2 via the through hole 7 formed on the back plate 2 from the glass pipe 3 is started (step S11). While blowing the nitrogen gas into, the front plate 1 and the back plate 2 are heated to a temperature about 10 to 70° C. higher than the fusing temperature of the glass frit 8 inside a heating furnace so that the peripheral sealing glass frit 8 is fused to seal the two glass substrates 1 and 2 (step S12).

Next, while the two sealed glass substrates 1 and 2 are being maintained at a temperature about 10 to 50° C. lower than the fusing temperature of the glass frit 8, the gap between the two glass substrates 1 and 2 is evacuated into vacuum through the through hole 7 (step S13).

After completion of the evacuation step, the two glass substrates 1 and 2 are cooled, and after having been cooled approximately to a normal temperature, a mixed gas of Xe and Ne serving as one example of an enclosed gas is introduced into the gap between the two glass substrates 1 and 2, and the gas introduction is stopped at a predetermined pressure (step S14).

Next, the glass pipe 3 is fused to be gas-sealed and cut off (step S15) so that a PDP is completed.

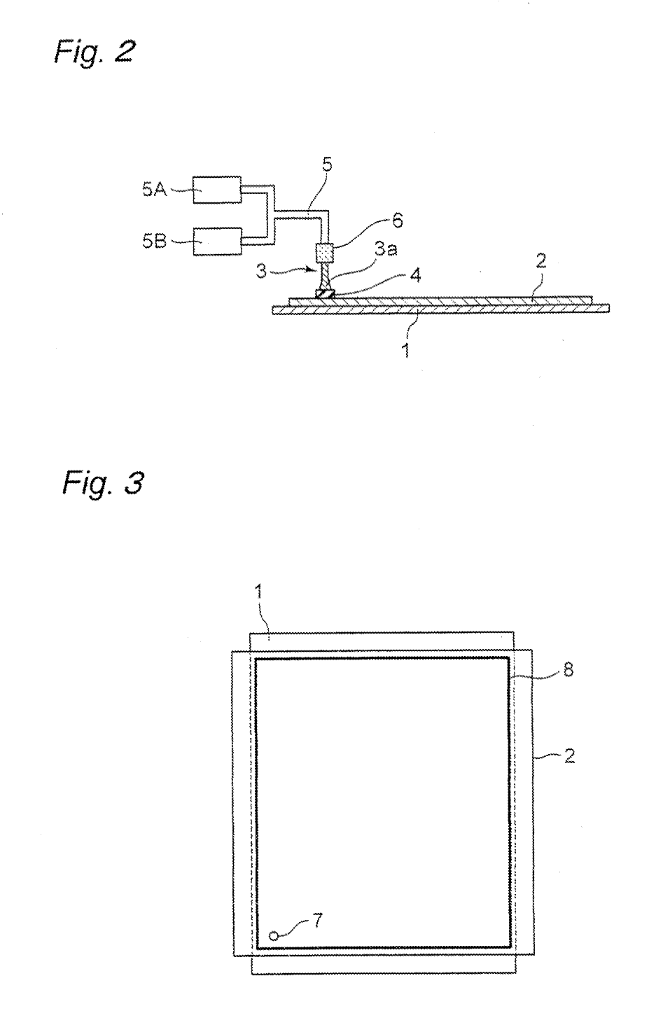

In this case, FIG. 2 is a side view showing a panel state in step S11 where the gas is blown into the space 20 inside the panel between the first and second glass substrates 1 and 2 from the gas blowing jig. In FIG. 2, the front plate 1 and the back plate 2 are superposed in parallel with each other. Moreover, the glass pipe 3 is pressed onto the back plate 2 so as to be fitted to the through hole 7 (not shown in FIG. 2, see FIG. 3) formed on the back plate 2, with the solid-state glass frit ring 4 interposed therebetween. The funnel-shaped glass fiber filter paper (not shown in FIGS. 2 and 3, see FIG. 4 or the like) is placed on the flare portion 3a of the glass pipe 3. A chuck head 6 forming the tip portion of the piping 5 is connected to the tip of the glass pipe 3 on the side opposite to the flare portion 3a. In the chuck head 6, water-cooling piping and a sealing mechanism, which are not shown, are disposed so that, even when the glass pipe 3 and the piping 5 are heated to the sealing temperature, a tightly-closed structure is integrally formed. A gas-supply device 5A and an exhaust device 5B are connected to the piping 5 so that a nitrogen gas, a Xe gas, and a Ne gas are supplied to the space 20 inside the panel by the gas supply device 5A, or the space 20 inside the panel can be evacuated by the exhaust device 5B.

FIG. 3 is a plan view showing the entire panel. In FIG. 3, the through hole 7 is formed at a position on the back plate 2 to which the glass pipe 3 is attached. The glass frit 8 is formed on four sides between the front plate 1 and the back plate 2 in a manner so as to surround portions of the front plate 1 and the back plate 2 that are overlapped with each other upon being bonded to each other, in the form of a square frame.

FIG. 4 is a cross-sectional view showing a layout on the periphery of the glass pipe 3 prior to the sealing. The front plate 1 and the back plate 2 are opposed to each other, with the glass frit 8 being interposed therebetween. Moreover, the glass pipe 3 is pressed onto the back plate 2, with the solid-state glass frit ring 4 interposed therebetween, so that the center axis of the glass pipe 3 and the center axis of the back plate through hole 7 coincide with each other, and on a portion ranging from the inside of the flare portion 3a of the glass pipe 3 to the back plate 2 through the solid-state glass frit ring 4, the glass fiber filter paper 9 formed into a cone shape or a funnel shape is disposed in a manner so as to cover a border portion between the flare portion 3a and the solid-state glass frit ring 4, as well as a border portion between the solid-state glass frit ring 4 and the back plate 2. Thus, the nitrogen gas supplied from the gas supply device 5A is further supplied to the space 20 inside the panel from the back plate through hole 7, via the piping 5 and the glass pipe 3. Since the glass fiber filter paper 9 is disposed on the portion ranging from the inside of the flare portion 3a of the glass pipe 3 to the back plate 2 through the solid-state glass frit ring 4, in a manner so as to cover the border portion between the flare portion 3a and the solid-state glass frit ring 4, as well as the border portion between the solid-state glass frit ring 4 and the back plate 2, a flow resistance of gases leaking externally through the gap between the glass pipe 3 and the solid-state glass frit ring 4 as well as the gap between the solid-state glass frit ring 4 and the back plate 2 is increased so that the gas leakage can be reduced. In addition, by disposing the glass fiber filter paper 9 on a portion ranging from the inside of the flare portion 3a of the glass pipe 3 to the solid-state glass frit ring 4 in a manner so as to cover the border portion between the flare portion 3a and the solid-state glass frit ring 4, the flow resistance of a gas leaking externally through the gap between the glass pipe 3 and the solid-state glass frit ring 4 is increased so that the gas leakage can also be reduced.

The blowing process of a nitrogen gas into the space 20 inside the panel is started at normal temperature. Then, the front plate 1 and the back plate 2 are heated in a heating furnace while the nitrogen gas is being blown thereto. When the fusing temperature of the glass frit 8 is exceeded, the glass frit 8 is softened so as to gradually fill the gap between the glass frit 8 and the front plate 1. Moreover, since the solid-state glass frit 4 is also made of the same material as the glass frit 8, the solid-state glass frit 4 is softened so that the glass pipe 3 and the back plate 2 are bonded to each other, with high sealing property. The panel is held at a temperature about 10 to 70° C. higher than the fusing temperature of the glass frit 8 for several minutes to several tens of minutes, and then the panel is cooled so that the glass frit 8 and the solid-state glass frit ring 4 are solidified. Thus, the two glass substrates 1 and 2 are sealed, with the glass pipe 3 being secured to the back plate 2. Next, while the two glass substrates 1 and 2 thus sealed are being held at a temperature about 10 to 50° C. lower than the fusing temperature at the time of sealing, the space 20 inside the panel between the two glass substrates 1 and 2 is evacuated into vacuum by using the exhaust device 5B through the piping 5, the glass pipe 3, and the back plate through hole 7.

FIG. 5 is a cross-sectional view showing a layout on the periphery of the glass pipe 3 after the sealing process. The front plate 1 and the back plate 2 are bonded to each other by the glass frit 8, and the glass pipe 3 and the back plate 2 are bonded to each other by the solid-state glass frit ring 4, respectively, with superior sealing property. Moreover, the glass fiber filter paper 9, disposed inside the flare portion 3a of the glass pipe 3 prior to sealing, is partially bonded to the glass pipe 3 and the back plate 2 by the solid-state glass frit ring 4 to remain inside the panel; however, since the glass fiber filter paper 9 is not altered by heat or the like, no adverse effects are given to the panel characteristics.

The flow rate of the nitrogen gas at the time of the blowing process, which is varied in its optimal value depending on the shape of the glass pipe 3, the size of the back plate through hole 7, the size of the panel, the thickness of the glass frit 8, the size of the concave/convex portion on the top, and the like, is generally set in a range from 0.1 SLM to 10 SLM (SLM refers to a unit indicating the amount of a supplied gas per minute in a standard state of the gas by using liters). When the flow rate of the gas is too low, the outside atmospheric air may be mixed therein, or the gas purifying process might become insufficient; and in contrast, when the flow rate of the gas is too high, great costs are required disadvantageously.

In accordance with the method for manufacturing a PDP according to the first embodiment, since the flow resistance of a gas leaking externally from the bonded portion of the glass pipe 3, that is, at least the gap of the border portion between the flare portion 3a and the solid-state glass frit ring 4 can be made greater by the glass fiber filter paper 9, it becomes possible to reduce the gas leakage. As a result, since the glass substrates 1 and 2 are heated and sealed with each other, with a flow of a nitrogen gas being present on the surface of the protective layer 55, impurities are isolated from the protective layer 55 as gases so that the protective layer 55 is purified, and consequently, the altered layer containing impurities can be removed. Moreover, since, of the nitrogen gas blown into the glass pipe 3, the amount of an externally leaked gas can be always kept small by the glass fiber filter paper 9 disposed inside the glass pipe 3, the altered layer on the surface of the protective layer can be easily removed without variations, for each of the panels at low costs, so that a method of manufacturing a plasma display panel having long panel lifetime can be achieved.

In contrast, conventional manufacturing methods have various issues as described below. In a method in which, after the protective layer forming process, processes up to the sealing process are continuously carried out under an atmosphere-controlled space, structures of a transporting system and a sealing device become extremely complicated, with the result that this method cannot be easily achieved. Moreover, a large space has to be always maintained in a vacuum state, and great costs are required. Moreover, in a method in which first and second glass pipes are installed on the front plate or the back plate, and a dry gas is supplied into the inside of the panel through the second glass pipe while the inside of the panel is being evacuated through the first glass pipe, since the two glass pipes are required, the structure of the sealing device becomes extremely complicated, with the result that this method cannot be easily achieved. In contrast, in the case where only one glass pipe is used, and a dry gas is supplied into the panel through this pipe prior to the sealing process, while an evacuation process is carried out through the glass pipe after the sealing process, since the amount of a gas leaking from the peripheral portion of the glass pipe upon supplying the dry gas becomes greater, a large amount of the dry gas is required so as to actually supply the dry gas of a predetermined amount or more to the inside of the panel. Moreover, since the amount of a dry gas leaking toward the peripheral portion greatly differs due to a minute difference in installation angles of the glass pipe and the glass substrates for each of the panels, greater variations occur in the amount of the dry gas to be actually supplied into the panel, with the result that the amount of the dry gas to be actually supplied to the inside of the panel greatly varies to cause variations in the operating voltage for the respective panels. Furthermore, in a method in which a heating furnace on which the front plate and the back plate are superposed with each other and placed is tightly-closed, and gases inside the heating furnace are evacuated while an atmospheric gas is introduced into the heating furnace, to carry out a panel sealing process, since most of the dry gas is allowed to flow outside the panel, the amount of gases to be used becomes greater. Further, since the heating furnace needs to have a tightly-closed container structure, and since the back plate needs to be moved under a high temperature, an extremely complicated device structure is required. Moving the back plate under a high temperature increases the possibility of deviations in alignments.

All of these various issues can be resolved by using the aforementioned manufacturing method.

Moreover, in the aforementioned manufacturing method, since, the heating process is carried out after the alignment, with the top portion of the glass frit 8 and the front plate 1 being in contact with each other, deviations in the alignment hardly occur at the time of the sealing, making it possible to achieve a manufacturing method with high reliability.

Since the aforementioned manufacturing method makes it possible to produce a PDP in a state where moisture, carbon dioxide or the like is hardly adsorbed not only on the surface of the protective layer 55, but also on the surface of each of the barrier rib 10 of the back plate 2, and the phosphor layers 59R, 59G, and 59B, hardly any gases, such as moisture and carbon dioxide, to cause alteration or deterioration of the surface of the protective layer are contained in the PDP that has been subjected to a bonding process. As a result, even when the PDP has been driven for a long period of time, hardly any alteration occurs in the protective layer 55 or the phosphor layers 59R, 59G, and 59B, due to impurity gases, such as H₂O or CO₂, discharged into the discharge space 21, so that it becomes possible to achieve a PDP that is less susceptible to changes in the discharge voltage, luminance, and the like, and superior in the panel lifetime.

Moreover, according to the manufacturing method, even in the case where an alkali-earth metal oxide (for example, calcium oxide, strontium oxide, or barium oxide) whose work function is smaller than that of magnesium oxide is used as the protective layer 55, it is possible to obtain a stable discharging characteristic.

Furthermore, in the PDP manufactured by the aforementioned method, since no altered layer is present on the surface of the protective layer 55, and since gas adsorption on the surface of the back plate is extremely small, there is an advantage that hardly any aging treatment is required or the aging treatment can be finished in a very short period of time. As a specific example, although depending on the types thereof, for example, the aging treatment, which has required about two hours in the conventional method, can be reduced to about 10 minutes which is about one-tenth of the conventional method.

### Second Embodiment

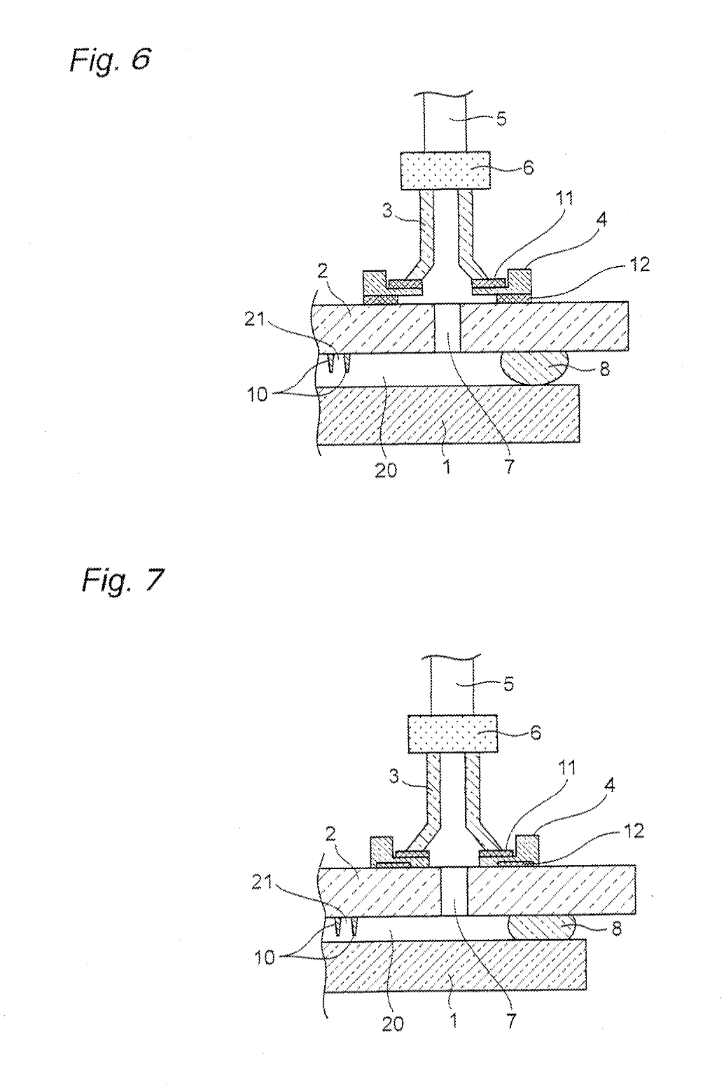

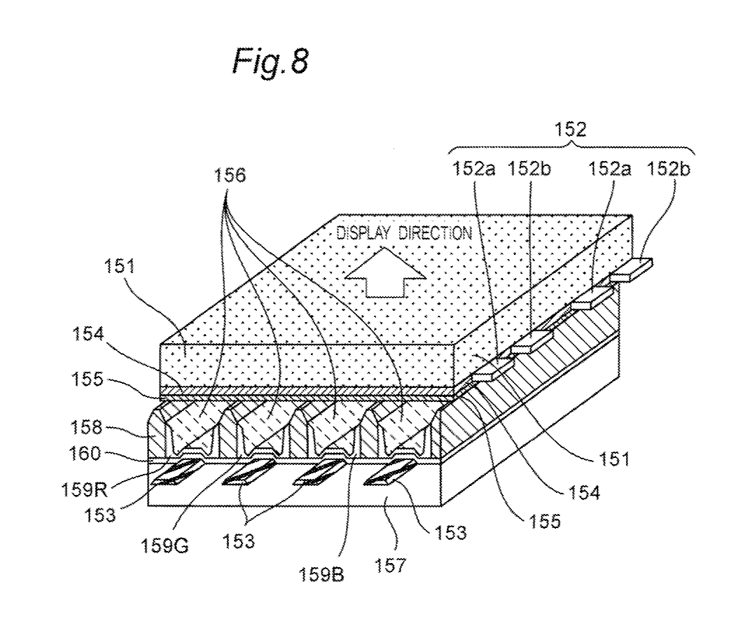

Hereinafter, a PDP according to a second embodiment of the present invention will be described with reference to FIG. 6.

FIG. 6 is a plan view showing a layout on the periphery of a glass pipe 3 in the PDP according to the second embodiment of the present invention.

A front plate 1 and a back plate 2 are aligned opposed to each other, with a glass frit 8 being interposed therebetween. Moreover, the glass pipe 3 is pressed onto the back plate 2 with the solid-state glass frit ring 4 interposed therebetween, in a manner so as to make the center axis of the glass pipe 3 and the center axis of the back plate through hole 7 coincident with each other. Planar glass fiber filter papers 11 and 12 having a round or square frame shape, which serve as one example of the glass fiber member, are respectively disposed between the flare portion 3a of the glass pipe 3 and the solid-state glass frit ring 4, as well as between the solid-state glass frit ring 4 and the back plate 2. The glass fiber filter paper 12 is made larger than the glass fiber filter paper 11. In other words, the glass fiber filter paper 11 is placed between the flare portion 3a of the glass pipe 3 and the solid-state glass frit ring 4, with the outside portion of the glass fiber filter paper 11 being externally extended from the flare portion 3a of the glass pipe 3. Moreover, the glass fiber filter paper 12 is placed between the solid-state glass frit ring 4 and the back plate 2, and disposed such that the outer peripheral portion of the glass fiber filter paper 12 is placed substantially at the same position as the outer peripheral portion of the solid-state glass frit ring 4. A chuck head 6 forming a tip portion of the piping 5 is connected to the tip of the glass pipe 3 on the side opposite to the flare portion 3a. Water-cooling piping and a sealing mechanism, which are not shown, are disposed in the chuck head 6 so as to maintain an integral tightly-closed structure even when the glass pipe 3 and the piping 5 are heated to a sealing temperature. A gas-supply device 5A and an exhaust device 5B are connected to the piping 5 so that a nitrogen gas, a Xe gas, and a Ne gas are supplied to the space 20 inside the panel by the gas supply device 5A, or the space 20 inside the panel can be evacuated by the exhaust device 5B.

For example, the planar glass fiber filter papers 11 and 12 to be used in this case contain no binder, and are made of only ultrathin borosilicate glass fibers having a diameter in a range of about 0.1 to 1 μm, with a thickness in a range of about 0.15 to 0.75 mm and a pressure loss of 0.17 kPa or more under a ventilation velocity of 5 cm/s. The planar glass fiber filter papers 11 and 12 are designed to have such dimensions that they can be sandwiched between the glass pipe 3 and the solid-state glass frit ring 4, or between the solid-state glass frit ring 4 and the back plate 2. The lower limit value is set to 0.17 kPa because, among commercially available products, this value corresponds to a specified value of the inexpensive product with the least pressure loss. As the upper limit value, since the gas leakage hardly occurs as the pressure loss becomes greater, and since this is considered to be advantageous, the upper limit value is not particularly required to be specified.

By using glass fibers containing no binder, alteration does not occur even when heated to about 500° C. at the time of sealing, and the pressure loss of a fixed level or more can be maintained, without causing any generation of impurity gases. In the second embodiment, glass fiber filter paper, made of only the ultrathin borosilicate glass fibers, is used; however, other glass fiber products that can realize the same shape, pressure loss and heat resistance may be used.

Thus, the nitrogen gas supplied from the gas supply device 5A is further supplied to the space 20 inside the panel from the back plate through hole 7, via the piping 5 and the glass pipe 3. The planar glass fiber filter papers 11 and 12 respectively increase the flow resistance of gases leaking externally through the gap between the glass pipe 3 and the solid-state glass frit ring 4 or the gap between the solid-state glass frit ring 4 and the back plate 2, thereby making it possible to reduce the gas leakage. Moreover, even in the case of a structure in which a glass pipe 3 that is integrally formed with the solid-state glass frit ring 4 by a method such as sintering is used, the planar glass fiber filter paper 12 is allowed to increase the flow resistance of gases leaking externally through the gap between the solid-state glass frit ring 4 and the back plate 2 so that the gas leakage can be reduced.

FIG. 7 is a cross-sectional view showing a peripheral layout of the glass pipe 3 after the sealing process. The front plate 1 and the back plate 2 are bonded to each other by the glass frit 8, and the glass pipe 3 and the back plate 2 are bonded to each other by the solid-state glass frit ring 4, respectively, with superior sealing property. Moreover, the planar glass fiber filter papers 11 and 12, which are sandwiched between the glass pipe 3 and the solid-state glass frit ring 4 as well as between the solid-state glass frit 4 and the back plate 2 prior to the sealing, are respectively bonded to the glass pipe 3 and the back plate 2 by the solid-state glass frit ring 4 to remain inside the panel; however, since the planar glass fiber filter papers 11 and 12 are not altered by heat or the like, no adverse effects are given to the panel characteristics.

The same functions and effects achieved by the first embodiment can also be obtained by the second embodiment. Moreover, since the glass pipe 3 and the frit ring 4 are individually sandwiched by the planar glass fiber filter papers 11 and 12, leakage is easily prevented, and since it is not necessary to form the glass fiber filter papers 11 and 12 into a special shape such as a funnel shape, and the glass filter papers 11 and 12 having a planar shape as they are can be used, processing and arranging processes thereof are comparatively easily carried out.

The manufacturing method of a PDP and the device according to the first and second embodiments are only typical examples within the applicable range of the present invention.

For example, the protective layer 55 is typically made from magnesium oxide, but may contain a trace amount of another element (such as silicon, aluminum, or the like). In general, at least one kind selected from the group consisting of magnesium oxide, calcium oxide, strontium oxides and barium oxide is preferably contained therein. By using calcium oxide, strontium oxide, or barium oxide, a PDP having a low driving voltage can be realized.

Alternatively, the protective layer 55 may be made from a mixture of at least two kinds selected from a group consisting of magnesium oxide, calcium oxide, strontium oxide, and barium oxide.

In the case of the above-exemplified material that can realize a PDP having a driving voltage that is lower than that of the structure in which magnesium oxide is used as the protective layer 55, in particular, the purifying effect obtained by gas-blowing at the time of the sealing process becomes greater so that the effectiveness of the present invention is remarkably exerted.

Moreover, the above description has exemplified a structure in which the front plate 1 and the back plate 2 are heated while a nitrogen gas is being blown thereto, and the gas to be used in this step is preferably an inert gas. Therefore, a rare gas, such as helium, argon, neon, or xenon, may be used. As the gas to be used in the step, at least a gas hardly containing any water vapor needs to be used. The moisture content of the gas to be used is preferably set to 1 ppm or the less. Since the nitrogen gas is comparatively expensive, an inexpensive manufacturing process may be obtained by using dry air.

Moreover, after glass frit has been applied thereon, calcination of the frit may be carried out prior to an alignment process. Alternatively, in the phosphor layer forming step, a batch firing process may be carried out simultaneously as the calcination of the frit, without carrying out the firing of the phosphor layer.

Furthermore, as one example of the enclosed gas, a process in which a mixed gas of Xe and Ne is enclosed between the two glass substrates 1 and 2 has been exemplified; however, only Xe may be enclosed therein, or a gas mixed with He may be used.

The blowing process of nitrogen gas, which is started at normal temperature, has been exemplified; however, by blowing the nitrogen gas only within a temperature range that is effective for removing an altered layer, the amount of use of the gas may be reduced.

By properly combining the arbitrary embodiments of the aforementioned various embodiments, the effects possessed by the embodiments can be produced.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

### INDUSTRIAL APPLICABILITY

The plasma display panel according to the present invention and the manufacturing method thereof can provide a PDP that has the protective layer having stable characteristics with high performance, and is stable in characteristics with high efficiency for a long period of time, and a method of manufacturing such a PDP, and can be effectively utilized for a display device for use in image display for televisions, computers, or the like, and a method of manufacturing such a device.

What is claimed is:

1. A method for manufacturing a plasma display panel comprising:
preparing a first glass substrate having an electrode, a dielectric layer, and a protective layer formed thereon, and a second glass substrate having an electrode, a dielectric layer, a barrier rib, and phosphor layers formed thereon;
disposing a glass frit on the first or second glass substrate;
superposing the first glass substrate and the second glass substrate with each other so that a top portion of the glass frit comes into contact with the glass substrate with no glass frit applied thereto;
disposing a glass fiber member, a glass pipe, and a solid-state glass frit near a through hole formed on the first or second glass substrate;
blowing a gas into a space between the first and second glass substrates via the through hole formed on the first or second glass substrate, and the glass;
fusing the glass frit so that the first and second glass substrates are sealed with each other, with the glass pipe being bonded to the first or second glass substrate;
evacuating a space between the first and second glass substrates; and
enclosing an enclosed gas between the first and second glass substrates.

2. The method for manufacturing a plasma display panel according to claim 1, wherein a protective layer, which includes at least one kind selected from a group consisting of magnesium oxide, calcium oxide, strontium oxide, and barium oxide, is used as the protective layer.

3. The method for manufacturing a plasma display panel according to claim 1, wherein a protective layer, which is made from a mixture of at least two kinds selected from a group consisting of magnesium oxide, calcium oxide, strontium oxide, and barium oxide, is used as the protective layer.

4. The method for manufacturing a plasma display panel according to claim 1, wherein, upon disposing the glass fiber member on a bonded portion of the glass pipe, a cone-shaped glass fiber member is placed on an inner surface of the glass pipe.

5. The method for manufacturing a plasma display panel according to claim 1, wherein, upon bonding the glass pipe, the glass pipe is bonded to a periphery of the through hole, with a solid-state glass frit interposed therebetween, so that the glass fiber member is sandwiched between the glass substrate on which the through hole is formed, and the solid-state glass frit, or between the glass pipe and the solid-state glass frit.

6. A plasma display panel comprising:
a first glass substrate having a protective layer;
a second glass substrate which is placed so as to be opposed to the first glass substrate to form a discharging space therebetween, with a peripheral portion between the first substrate and the second substrate being sealed with a sealing member, and with a glass pipe for use in sealing a gas into the discharging space or evacuating a gas therefrom being bonded to a periphery of a through hole formed on the first glass substrate or the second glass substrate so as to be connected to the through hole, wherein
a glass fiber member is disposed on a bonded portion of the glass pipe which is bonded to the periphery of the through hole formed on the first glass substrate or the second glass substrate.

7. The plasma display panel according to claim 6, wherein the protective layer includes at least one kind selected from a group consisting of magnesium oxide, calcium oxide, strontium oxide, and barium oxide.

8. The plasma display panel according to claim 6, wherein the protective layer is made from a mixture of at least two kinds selected from a group consisting of magnesium oxide, calcium oxide, strontium oxide, and barium oxide.

9. The plasma display panel according to claim 6, wherein the glass fiber member disposed on the bonded portion of the glass pipe is a cone-shaped glass fiber member placed on an inner surface of the glass pipe.

10. The plasma display panel according to claim 6, wherein, on the bonded portion of the glass pipe, the glass pipe is bonded to the periphery of the through hole, with a solid-state glass frit interposed therebetween, so that the glass fiber member is sandwiched between the glass substrate on which the through hole is formed, and the solid-state glass frit, or between the glass pipe and the solid-state glass frit.
